(19) United States
(12) Patent Application Publication
(10) Pub. No.: US 2012/0293751 A1
(43) Pub. Date: Nov. 22, 2012

(54) LIQUID CRYSTAL DEVICE AND ELECTRONIC APPARATUS INCLUDING THE SAME

(75) Inventors: Toshiharu Matsushima, Tottori (JP); Hideki Kaneko, Tottori (JP)

(73) Assignee: Sony Corporation, Tokyo (JP)

(21) Appl. No.: 13/460,964

(22) Filed: May 1, 2012

(30) Foreign Application Priority Data
May 20, 2011 (JP) 2011-113951

(51) Int. Cl. G02F 1/13363

(52) U.S. Cl. 349/96

(57) ABSTRACT

Disclosed herein is a liquid crystal device, including: a liquid crystal layer; a reflective layer for reflecting an outside light made incident thereto through the liquid crystal layer; and a retardation layer and a polarizing plate both disposed on a side to which the outside light is made incident in relation to the liquid crystal layer, wherein the retardation layer has an optical biaxial property.

### BACKGROUND

The present technology relates to a reflective liquid crystal device or a semi-transmissive liquid crystal device having a transmission display portion as well as a reflection display portion, and an electronic apparatus including the same as a display portion thereof.

The combining of a λ/4 plate and a λ/2 plate is known as a method of composing a retarder (λ/4 plate) in a liquid crystal display device. In addition, a liquid crystal display device having a transverse electric field drive liquid crystal mode attracts attention as a liquid crystal display device having a liquid crystal mode which realizes both of a wide angle of field, and a high contrast in such a liquid crystal display device. This technique, for example, is disclosed in Japanese Patent Laid-Open Nos. 2001-330844 and 2008-52161. For example, there is known a method in which a retarder (λ/2 plate) is provided in a liquid crystal layer, and λ/4 is set in the liquid crystal layer in the transverse electric field drive liquid crystal mode.

### SUMMARY

Now, the method exemplified above involves a problem that although a transmittance in a front surface direction becomes lowest during black display, light leakage is caused in an oblique direction, and thus a contrast rate in the oblique direction is not increased so much.

The present technology has been made in order to solve the problems described above, and it is therefore desirable to provide a liquid crystal device in which a contrast ratio in an oblique direction can be increased, and an electronic apparatus including the same.

In order to attain the desire described above, according to an embodiment of the present technology, there is provided a liquid crystal device including: a liquid crystal layer; a reflective layer for reflecting an outside light made incident thereto through the liquid crystal layer; and a retardation layer and a polarizing plate both disposed on a side to which the outside light is made incident in relation to the liquid crystal layer, in which the retardation layer has an optical biaxial property.

According of another embodiment of the present technology, there is provided an electronic apparatus including: a liquid crystal device as a display portion, the liquid crystal device including: a liquid crystal layer; a reflective layer for reflecting an outside light made incident thereto through the liquid crystal layer; and a retardation layer and a polarizing plate both disposed on a side to which the outside light is made incident in relation to the liquid crystal layer, in which the retardation layer has an optical biaxial property.

In the liquid crystal device of the embodiment and the electronic apparatus of another embodiment, the retardation layer disposed on the side to which the outside light is made incident in relation to the liquid crystal layer has the optical biaxial property. As a result, during the black display, the light leakage becomes less not only in the front surface side, but also in the oblique direction.

In the embodiments of the present technology, preferably, the retardation layer has an Nz coefficient which is equal to or larger than 0 and equal to or smaller than 0.5. When such a structure is adopted, the light leakage during the black display becomes less in a direction crossing at an angle of 40 degrees or less with a normal line to the liquid crystal device. In addition, in the embodiments of the present technology, preferably, the retardation layer and the liquid crystal layer both function as a λ/4 plate having a broad-band. In this case, the light leakage during the black display becomes less in the broad-band.

In addition, in the embodiments of the present technology, when the liquid crystal device is set in a Fringe Field Switching (FFS) mode, preferably, pixel electrodes are formed below a common electrode having a slit formed therein, and the pixel electrodes and the common electrode both function as a reflective layer. In this case, a white luminance is enhanced.

As set forth hereinabove, according to the liquid crystal device and the electronic apparatus of the present technology, during the black display, the light leakage is made less not only in the front surface direction, but also in the oblique direction through the optical compensation by the retarder. Therefore, it is possible to enhance the contrast ratio in the oblique direction.

In addition, according to the present technology, when the retardation layer is given the Nz coefficient which is equal to or larger than 0 and equal to or smaller than 0.5, the contrast ratio can be made equal to or larger than 20 in the direction crossing at the angle of 40 degrees or less with the normal line to the liquid crystal device. In addition, in the present technology, when the retardation layer and the liquid crystal layer both function as the λ/4 plate having the broad-band, it is possible to enhance the contrast ratio in the broad-band. In addition, in the present technology, when the liquid crystal device is constructed so as to have the FFS mode, the pixel electrodes are formed below the common electrode having the slit formed therein, and when the pixel electrodes and the common electrode are both made to function as the reflective layer, it is possible to further enhance the contrast ratio.

### BRIEF DESCRIPTION OF THE DRAWINGS

FIG. 1 is a cross sectional view showing a structure of a liquid crystal device according to a first embodiment of the present technology;

FIG. 2 is a partial enlarged top plan view showing a structure of a part of the liquid crystal device of the first embodiment shown in FIG. 1;

FIG. 3 is a partial top plan view showing a structure of a common electrode of the liquid crystal device of the first embodiment shown in FIG. 1;

FIG. 4 is a view representing angle-of-field characteristics when a retardation layer having an optical uniaxial property is used as the retardation layer;

FIG. 5 is a view representing angle-of-field characteristics when a retardation layer having an optical biaxial property (Nz coefficient=0) is used as the retardation layer;

FIG. 6 is a view representing angle-of-field characteristics when a retardation layer having an optical biaxial property (Nz coefficient=0.5) is used as the retardation layer; and

FIG. 7 is a perspective view showing a construction of a mobile phone as an electronic apparatus according to an example of application in which the liquid crystal device according to the first embodiment of the present technology is applied.

### DETAILED DESCRIPTION OF THE PREFERRED EMBODIMENTS

Embodiments of the present technology will be described in detail hereinafter with reference to the accompanying drawings. It is noted that the description will be given below in accordance with the following order:

1. First Embodiment (Liquid Crystal Device);

The case where a retardation layer having an Nz coefficient equal to or larger than 0 and smaller than 1

2. Modified Examples;

3. Second Embodiment (Electronic Apparatus); and

4. Example of Application.

The case where the liquid crystal device of the first embodiment is used as a display portion of the electronic apparatus of the second embodiment

### 1. FIRST EMBODIMENT

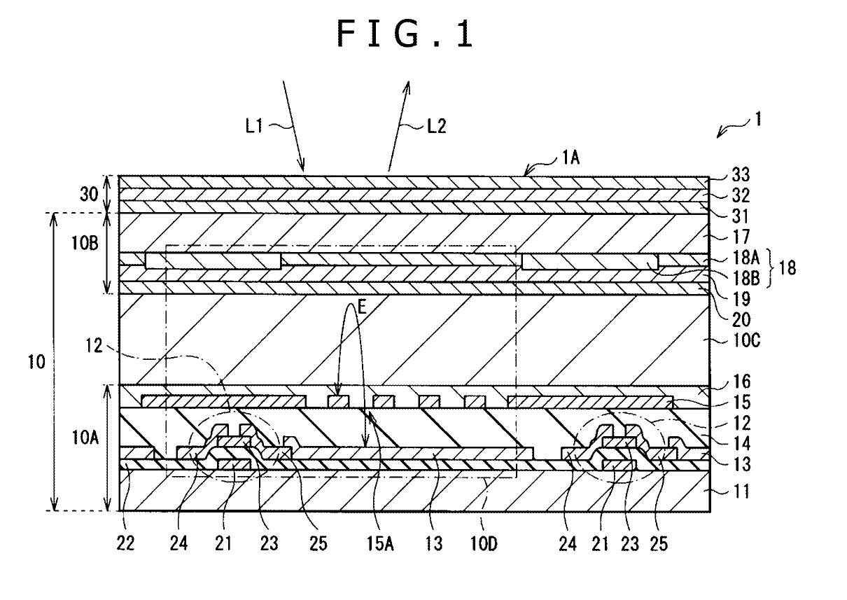

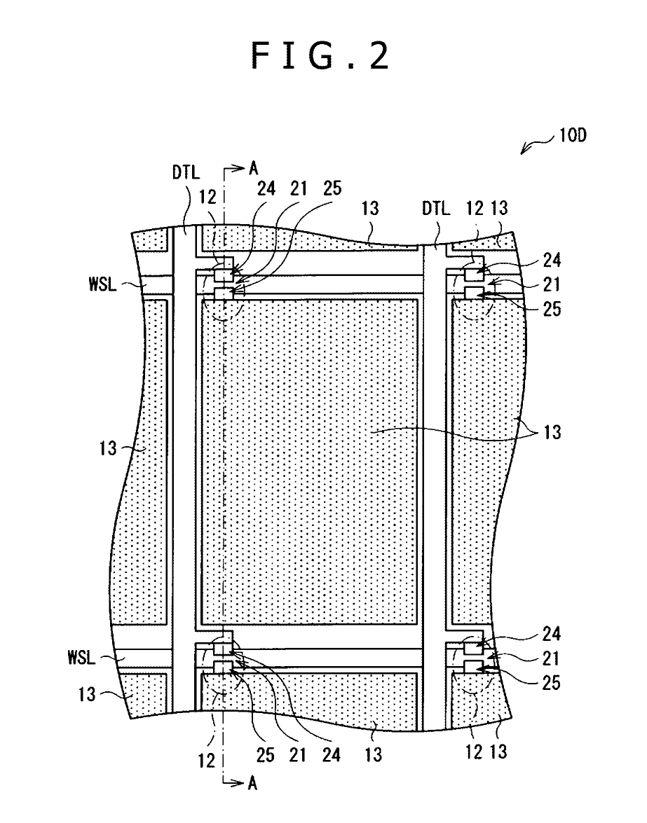

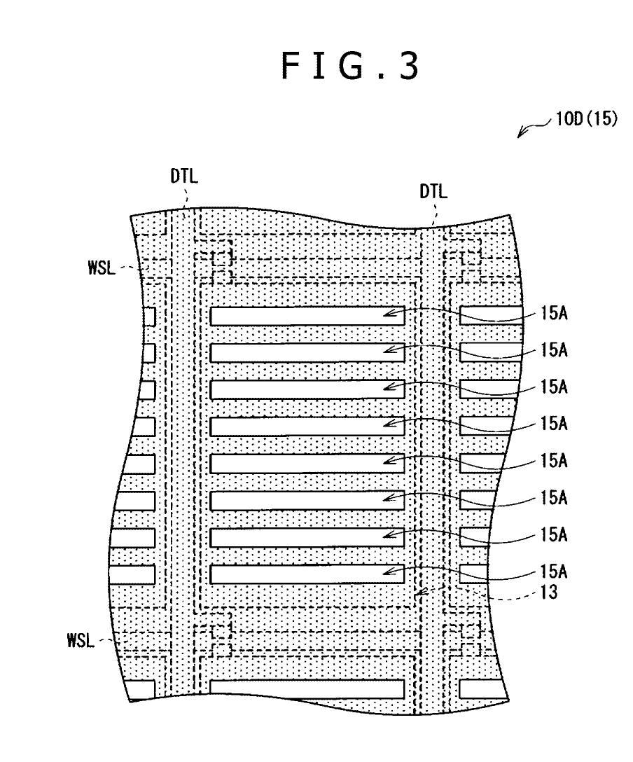

FIG. 1 is a cross sectional view showing a structure of a liquid crystal device 1 according to a first embodiment of the present technology. FIGS. 2 and 3 respectively show planar structures in predetermined layers of a pixel within the liquid crystal device 1 shown in FIG. 1. It is noted that FIG. 1 corresponds to a cross sectional view taken on line A-A of FIG. 2. Also, FIGS. 1 to 3 show schematically a size and a shape of the liquid crystal device 1, and thus the size and the shape are not necessarily identical to the actual size and shape, respectively.

The liquid crystal device 1 is constructed by sticking a lamination film 30 onto a liquid crystal display panel 10. In addition, the liquid crystal device 1 includes a drive circuit (not shown) for driving the liquid crystal display panel 10. In the liquid crystal device 1, an upper surface of the lamination film 30 is structured as an image display surface 1A, and a light source such as a backlight is not disposed on the back of the liquid crystal display panel 10. In a word, the liquid crystal display panel 10 is a reflective display panel for modulating an outside light L1 made incident thereto from the image display surface 1A side in accordance with an image signal and reflecting the outside light L1 to generate an image light L2, and outputting the resulting the image light L2 from the image display surface 1A.

The liquid crystal display panel 10 has a construction in which a liquid crystal layer 10C is sandwiched between a lower side panel substrate 10A and an upper side panel substrate 10B. The lower side panel substrate 10A, for example, as shown in FIGS. 1 and 2, includes plural transistors 12 which are two-dimensionally disposed on a substrate 11, and plural pixel electrodes 13 which are connected to the transistors 12, respectively. It is noted that the substrate 11 corresponds to a concrete example of “a first substrate” in the present technology. The liquid crystal display panel 10 includes plural pixels 10D which are two-dimensionally disposed, and also includes the transistor 12 and the pixel electrode 13 every pixel 10D. It is noted that the pixel 10D corresponds to a concrete example of “a pixel” in the present technology. The transistor 12 corresponds to a concrete example of “a switching element” in the present technology. Also, the pixel electrode 13 corresponds to a concrete example of “a reflective layer” as well as “a pixel electrode.” The transistors 12, for example, as shown in FIG. 2, are provided so as to correspond to intersection points between gate lines WSL each extending in a row direction, and data lines DTL each extending in a column direction, respectively. Also, the pixel electrodes 13, for example, as shown in FIG. 2, are formed over approximately all of areas each surrounded by each adjacent two gate lines WSL and the corresponding two lines DTL.

The transistor 12, for example, is composed of a field effect type Thin Film Transistor (TFT). Thus, the transistor 12 is configured so as to include a gate for controlling a channel, and a source and a drain which are provided on both sides of the channel, respectively. Also, the transistor 12, for example, includes a gate electrode 21 formed on the substrate 11, and a gate insulating film 22 formed on a surface including a principal surface of the substrate 11 and an upper surface of the gate electrode 21, as shown in FIG. 1. In addition, the transistor 12, for example, as shown in FIG. 1, includes the channel 23 in a position, facing the gate electrode 21, of an upper surface of the gate insulating film 22, and a source electrode 24 and a drain electrode 25 both of which contact the channel 23.

The pixel electrode 13 is connected to the drain electrode 25 and is also formed in the same layer as that of the drain electrode 25. The pixel electrode 13 does not have intentional irregularities on an upper surface thereof, and thus the upper surface of the pixel electrode 13 is a flat surface. In addition, preferably, the pixel electrode 13 is made of a metallic material (for example, a metallic material such as an Al—Nd alloy), and functions as a reflective layer for reflecting a visible light. In a word, the pixel electrode 13 functions as the reflective layer for reflecting the outside light L1 made incident thereto through the liquid crystal layer 10C. It is noted that although not illustrated, the pixel electrode 13 may be formed in an upper layer with respect to the layer in which the drain electrode 25 is formed. In this case, however, it is necessary to provide a contact hole through which the pixel electrode 13 and the drain electrode 25 are connected to each other in a lamination direction.

For example, as shown in FIG. 1, the lower side panel substrate 10A includes an insulating layer 14 on a surface having an upper surface of the transistor 12 and an upper surface of the pixel electrode 13. Also, the lower side panel substrate 10A includes a common electrode 15 and an alignment film 16 on an upper surface of the insulating layer 14. It is noted that the common electrode 15 corresponds to a concrete example of “a reflective layer” as well as “a common electrode” in the present technology.

The common electrode 15 is formed so as to cover positions facing the pixel electrodes 13 through the insulating layer 14, respectively, and is also planarly formed over the entire insulating layer 14 (specifically, the entire display area formed by the pixel electrodes 13). Therefore, the common electrode 15 functions as a common electrode formed so as to cover positions facing the pixel electrodes 13, respectively. The common electrode 15, for example, as shown in FIG. 3, has plural slits 15A in areas each facing the corresponding one of the pixel electrodes 13. It is noted that the slit 15A corresponds to a concrete example of “a slit” in the present technology. Each of the slits 15A is a rectangle-shaped opening which extends in one direction (for example, in a direction parallel with an extending direction of each of the gate lines WSL) within the plane. It is noted that the extending direction of each of the slits 15A within the plane may be any other suitable direction other than the direction described above. The common electrode 15 does not have intentional irregularities on the upper surface thereof, and thus the upper surface of the common electrode 15 becomes a flat surface. In addition, preferably, the common electrode 15 is made of a metallic material (for example, a metallic material such as an Al—Nd alloy), and functions as the reflective layer for reflecting the visible light. In a word, the common electrode 15 functions, together with the pixel electrodes 13, as the reflective layer for reflecting the outside light L1 made incident thereto through the liquid crystal layer 10C.

The alignment film 16 is used to align liquid crystal molecules contained in the liquid crystal layer 10C in a predetermined direction, and thus directly contacts the liquid crystal layer 10C. The alignment film 16, for example, is made of a high-molecular material such as polyimide and, for example, is formed by subjecting applied polyimide or the like to a rubbing treatment.

The upper side panel substrate 10B, for example, as shown in FIG. 1, includes a filter layer 18, an overcoat layer 19, and the alignment film 20 in this order on a surface on the side, of the liquid crystal layer 10C, of the substrate 17. It is noted that the substrate 17 corresponds to a concrete example of “a second substrate” in the present technology. The filter layer 18 includes a color filter layer 18A formed so as to cover positions facing the pixel electrodes 13, respectively, and includes a light blocking layer 18B formed so as to cover positions other than the positions facing the pixel electrodes 13, respectively. In the color filter layer 18A, color filters which either, for example, color-separate a light transmitted through the liquid crystal layer 10C into the three primary colors of red (R), green (G), and blue (B) or, for example, color-separate the light concerned into four colors of R, G, B, and white are disposed so as to correspond to the disposition of the pixel electrode 13. The light blocking layer 18B, for example, has a function of absorbing the visible light.

The alignment film 20 is used to align the liquid crystal molecules contained in the liquid crystal layer 10C in a predetermined direction, and thus directly contacts the liquid crystal layer 10C similarly to the case of the alignment film 16. The alignment film 20, for example, is made of a high-molecular material such as polyimide and, for example, is formed by subjecting the applied polyimide or the like to the rubbing treatment.

The liquid crystal layer 10C, for example, is composed of a Nematic liquid crystal. The liquid crystal layer 10C has a modulation function of either transmitting or blocking the outside light L1 every pixel 10D by using a voltage applied thereto from the drive circuit. It is noted that the liquid crystal layer 10C can adjust a gradation for each pixel 10D by changing a light transmission level of the liquid crystal layer 10C concerned.

A lamination film 30, for example, as shown in FIG. 1, is structured in such a way that a retardation film 31, a forward scattering film 32, and a polarizing plate 33 are laminated in this order from the liquid crystal display panel 10 side. It is noted that in the lamination film 30, some sort of layer(s) (not shown in FIG. 1) may also be further added thereto. The retardation film 31 corresponds to a concrete example of “a retarder layer” in the present technology. Also, the polarizing plate 33 corresponds to a concrete example of “a polarizing plate” in the present technology.

The retardation film 31 has a function as a retarder film for compensating for an angle of field. The retardation film 31 has an optical biaxial property, and has an Nz coefficient which is equal to or larger than 0 and smaller than 1 and preferably, has the Nz coefficient which is equal to or larger than 0 and smaller than 0.5. Here, the Nz coefficient means a coefficient which, when let nx and ny (nx≧ny) be the principal indices of refraction within a plane of the retardation film 31, and let nz be a refractive index in a thickness direction, is obtained from an expression of (nx−nz)/(nx−ny). When the Nz coefficient is set equal to or larger than 0 and smaller than 0.5, a compensation effect which will be described later especially becomes high. The retardation film 31, for example, is obtained by subjecting a high-molecular film to biaxial drawing. The retardation film 31 is preferably composed of a single film.

The retardation film 31 is adapted to function together with the liquid crystal layer 10C as a λ/4 plate having a broad-band (having small wavelength dependency). Specifically, when the liquid crystal layer 10C has a retardation of λ/4, the retardation film 31 has a retardation of λ/2 accordingly.

The forward scattering film 32 is disposed between the retardation film 31 and the polarizing plate 33. It is noted that the forward scattering film 32 may also be disposed between the substrate 17 and the retardation film 31. The forward scattering film 32 has the optical characteristics in which the forward scattering is relatively large, while the backward scattering is relatively small. The forward scattering film 32, for example, is composed of a resin layer containing therein filler. It is noted that, for example, an adhesive layer containing therein the filler may also be provided instead of providing the forward scattering film 32. Paste, for example, is given as a material for the adhesive layer.

The polarizing plate 33 has a function of absorbing a predetermined linear polarization component, and transmitting any of polarization components other than the predetermined linear polarization component. Therefore, the polarizing plate 33 has a function of converting the outside light made incident thereto from the outside into the linearly polarized light.

Next, an operation and effects of the liquid crystal device 1 according to the first embodiment of the present technology will be described in detail.

In the liquid crystal device 1 of the first embodiment, the outside light L1 is converted into the linearly polarized light by the polarizing plate 33, rotated to a predetermined angle by the retardation film 31 while the linearly polarized light is approximately maintained as it is, and is scattered by the forward scattering film 32, thereby being made incident to the liquid crystal display panel 10.

Of the light made incident to the liquid crystal display panel 10, a part thereof which has been made incident to the liquid crystal layer 10C (for example, a region in which the liquid crystal molecules are aligned in a direction parallel with the lower side panel substrate 10A) to which no voltage is applied is converted into a circularly polarized light by the liquid crystal molecules to reach each of the pixel electrode 13 and the common electrode 15, thereby being reflected by each of the pixel electrode 13 and the common electrode 15. When the reflected light traces a reverse path to reach the polarizing plate 33, the reflected light has a transmission axis in a direction orthogonal to a transmission axis of the polarizing plate 33. For this reason, the reflected light is absorbed by the polarizing plate 33. Therefore, in this case, the pixel 10D offers dark display.

In addition, of the light which has been incident to the liquid crystal display panel 10, a part thereof made incident to the liquid crystal layer 10C (for example, a region in which the liquid crystal molecules are aligned along an electric field E) to which the voltage is applied is approximately converted into the linearly polarized light by the liquid crystal layer 10C to reach each of the pixel electrode 13 and the common electrode 15. The reason for this is because the retardation and a twist angle of the liquid crystal layer 10C are previously set so as to provide such a situation. The reflected light traces a reverse path to be converted into the linearly polarized light parallel with the polarizing plate 33, thereby passing through the polarizing plate 33. Therefore, in this case, the pixel 10D offers light display.

Now, in the liquid crystal device 1 of the first embodiment, the slits 15A of the common electrode 15, and the corresponding one of the pixel electrodes 13 face each other in the lamination direction. For this reason, when a predetermined voltage is applied across the pixel electrode 13 and the common electrode 15, an electric field is generated in a transverse direction in a portion, right above the slits 15A, of the liquid crystal layer 10C. In addition, an electric field is generated in an oblique direction in a portion (a portion, right above a portion other than the slits 15A, of the common electrode 15), other than the portion right above the slits 15A, of the liquid crystal layer 10C. As a result, an FFS mode is realized, and thus both of a wide angle of view, and a high aperture ratio are obtained.

In addition, in the liquid crystal device 1 of the first embodiment, each of the pixel electrodes 13 and the common electrode 15 acts as the reflective electrode. As a result, since the light which has passed through the slits 15A is reflected by the pixel electrodes 13, a white luminance can be increased as compared with the case where each of the pixel electrodes 13 does not act as the reflective electrode. In addition thereto, in the liquid crystal device 1 of the first embodiment, each of the pixel electrodes 13 is formed in the same layer as that of each of the drain electrodes 25 of the transistors 12. As a result, it is possible to omit the contact hole which is necessary when each of the pixel electrodes 13 is disposed above the corresponding one of the drain electrodes 25. As a result, a reflection quantity of light on each of the pixel electrodes 13 can be increased all the more because any of the contact holes is omitted, and thus it is possible to increase the white luminance. Each of the pixel electrodes 13 and the common electrode 15 is formed so as to act as the reflective electrode, and each of the pixel electrodes 13 is formed in the same layer as that of the corresponding one of the drain electrodes 25 in the manner as described above, thereby making it possible to increase the white luminance. As a result, it is possible to increase the contrast ratio as well.

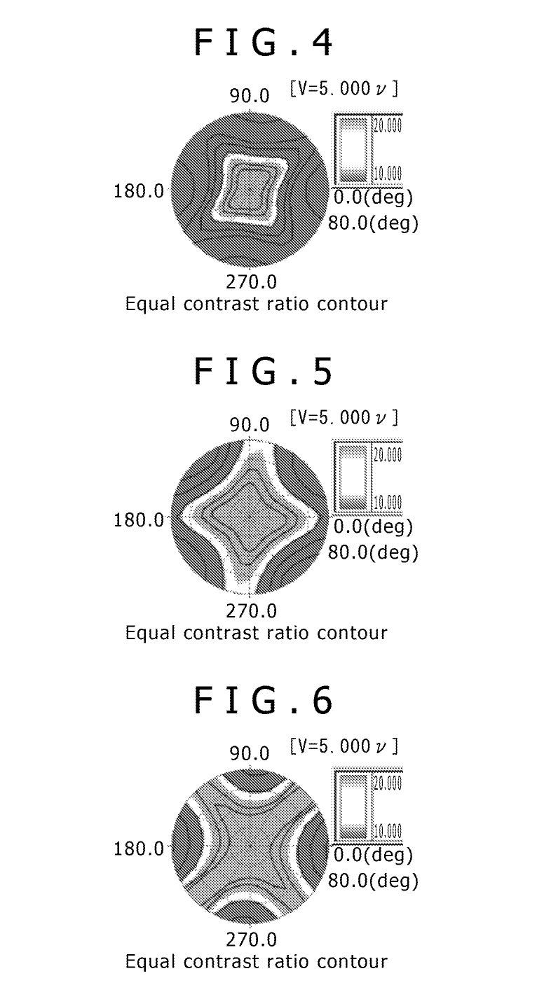

Now, the combining of the λ/4 plate and the λ/2 plate is known as a method of composing the retarder (λ/4 plate) in the liquid crystal display device. For example, there is known a method in which in a transverse electric field drive liquid crystal mode, a retardation layer (λ/2 plate) is provided on a liquid crystal layer, and λ/4 is set in the liquid crystal layer. However, with the existing method, an A plate having an optical uniaxial property is used as the retardation layer. For this reason, although during the black display, the transmittance in the front surface direction becomes lowest, the light leakage is generated in the oblique direction. For this reason, for example, there is caused a problem that, as shown in FIG. 4, the contrast ratio in the oblique direction is abruptly reduced in the range of 0 to 40 degrees.

On the other hand, in the liquid crystal device 1 of the first embodiment, the retardation film 31 has the optical biaxial property. As a result, during the black display, the light leakage becomes less not only in the front surface direction, but also in the oblique direction. As a result, it is possible to increase the contrast ratio in the oblique direction.

In addition, in the liquid crystal device 1 of the first embodiment, when the retardation film 31 is given the Nz coefficient which is equal to or larger than 0 and equal to or smaller than 0.5, the contrast ratio can be made equal to or larger than 20 in the direction crossing at the angle of 40 degrees or less with the normal line to the liquid crystal device 1. For example, when either the retardation film 31 having the Nz coefficient of 0 is used (refer to FIG. 5), or the retardation film 31 having the Nz coefficient of 0.5 is used (refer to FIG. 6), it is understood that the contrast ratio in the oblique direction is equal to or larger than 20 in the range of 0 to 40 degrees. In addition thereto, the abrupt change in the contrast ratio is prevented from being generated in the range of 0 to 40 degrees. Therefore, the using of a retardation film 31 having the Nz coefficient which is equal to or larger than 0 and equal to or smaller than 0.5 as the retardation film 31 results in that it is possible to obtain the excellent angle-of-field characteristics.

In addition, since in the liquid crystal device 1 of the first embodiment, the retardation film 31 is adapted to function together with the liquid crystal layer 10C as the λ/4 plate having the broad-band (having the small wavelength dependency), the contrast can be enhanced in the broad-band.

### 2. MODIFIED EXAMPLES

Next, liquid crystal devices according to modified examples of the first embodiment described above will be described. It is noted that, of course, the modified examples which will be described below can be combined with one another in a mutually-consistent range.

### First Modified Example

Although in the liquid crystal device 1 of the first embodiment, the liquid crystal display panel 10 is of the reflection type, the liquid crystal display panel 10 may also be a semi-transmissive one including a transmission display portion as well as the reflection display portion. In this case, however, preferably, a backlight is provided on the back of the liquid crystal display panel 10, and a retardation layer having the same optical structure as that of the retardation film 31 is provided within the upper side panel substrate 10B instead of providing the retardation film 31.

### Second Modified Example

In addition, although in the liquid crystal device 1 of the first embodiment, the liquid crystal display panel 10 has the FFS mode set therein, the liquid crystal display panel 10 may also have any other suitable transverse electric field drive mode set therein, for example, an In-Plain Switching (IPS) mode.

### Third Modified Example

In addition, although in the liquid crystal device 1 of the first embodiment, each of the pixel electrodes 13 is formed in the same layer as that of the corresponding one of the drain electrodes 25, each of the pixel electrodes 13 may also be formed in an upper layer with respect to the corresponding one of the drain electrodes 25.

### Fourth Modified Example

In addition, although in the liquid crystal device 1 of the first embodiment, the pixel electrodes 13 are formed below the common electrode 15, the pixel electrodes 13 may also be formed above the common electrode 15. In this case, however, preferably, plural slits are provided in each of the pixel electrodes 13, and the common electrode 15 is composed of a solid film having no slit formed therein.

### Fifth Modified Example

In addition, although in the liquid crystal device 1 of the first embodiment, the transistor 12 is of the three terminal type, the transistor 12 may also be of a two terminal type. It is noted that the two terminal type transistor, for example, includes a Thin Film Diode (TFD).

### 3. SECOND EMBODIMENT

An electronic apparatus according to a second embodiment of the present technology includes the liquid crystal device 1 according to the first embodiment of the present technology as a display portion thereof. In this case, the liquid crystal device 1, as described above, includes the liquid crystal layer 10C, the reflective layer for reflecting the outside light L1 made incident thereto through the liquid crystal layer 10C, and the retardation layer and the polarizing plate 33 both disposed on the side to which the outside light L1 is made incident in relation to the liquid crystal layer 10C. In this case, as described above, the reflective layer is composed of the pixel electrodes 13 and the common electrode 15. Also, the retardation layer is composed of the retardation film 31. In addition, the retardation layer has the optical biaxial property.

It is noted that the electronic apparatus of the second embodiment including the liquid crystal device 1 of the first embodiment, for example, includes a mobile phone, a personal computer, a liquid crystal television set, a view finder type or monitor direct-view-type video tape recorder, a car navigation device, a pager, an electronic databook, a calculator, a word processor, a work station, a TV (telephone) telephone set, a POS (Point of Sale) terminal device, and the like.

It is noted that although the electronic apparatus of the second embodiment includes the liquid crystal device 1 of the first embodiment, alternatively, the electronic apparatus of the second embodiment can also include any of the liquid crystal devices according to the first to fifth modified examples of the first embodiment.

### 4. EXAMPLE OF APPLICATION

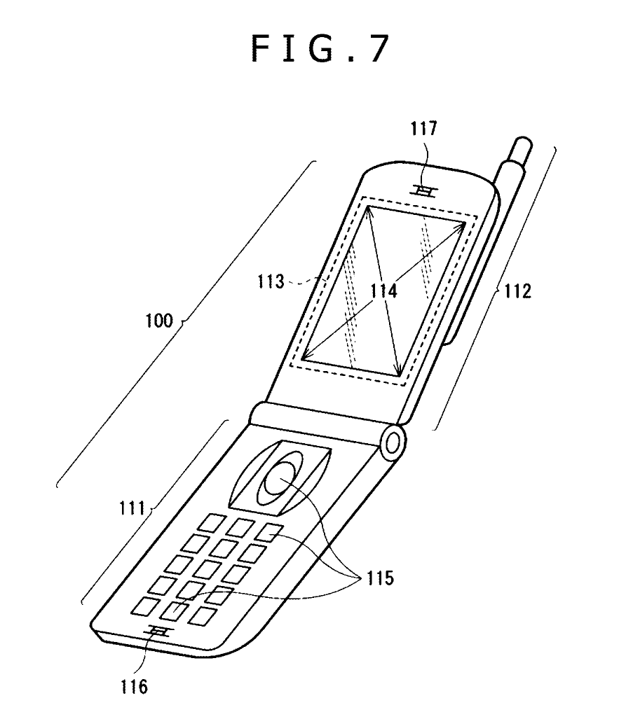

Next, a description will be given below with respect to an example of application in which the liquid crystal device 1 of the first embodiment is applied to the electronic apparatus of the second embodiment. FIG. 7 is a perspective view showing a schematic construction of an electronic apparatus 100 according to the example of application. The electronic apparatus 100 is a mobile phone. For example, as shown in FIG. 7, the electronic apparatus 100 includes a main body portion 111 and a display portion 112 which is provided so as to be openable and closable for the main body portion 111. The main body portion 111 includes a manipulation button 115 and a transmitter portion 116. The display portion 112 includes a display device 113 and a receiver portion 117. The display device 113 is adapted to display various kinds of displays about telephone communications on a display screen 114 of the display device 113. The electronic apparatus 100 includes a control portion (not shown) for controlling an operation of the display device 113. The control portion is provided either as a part of a control section for taking charge of control for the entire electronic apparatus 100 or separately from the control section inside either the main body portion 111 or the display portion 112.

The display device 113 has the same structure as that of the liquid crystal device 1 according to the first embodiment of the present technology. As a result, a user can visually recognize an image having a high contrast ratio not only in the front direction, but also in the oblique direction.

It is noted that the display device 113 can have the same structure as that of the liquid crystal device according to any of the first to fifth modified examples of the first embodiments.

For this reason, although the liquid crystal device 1 of the first embodiment is applied as the example of application to the electronic apparatus, alternatively, the liquid crystal device according to any of the first to fifth modified examples of the first embodiment can also be applied as another example of application to the electronic apparatus.

In addition, for example, the present technology can adopt the following constitutions.

(1)

A liquid crystal device including a liquid crystal layer, a reflective layer for reflecting an outside light made incident thereto through the liquid crystal layer, and a retardation layer and a polarizing plate both disposed on a side to which the outside light is made incident in relation to the liquid crystal layer, in which the retardation layer has optical biaxial property.

(2)

The liquid crystal device described in the paragraph (1), in which the retardation layer has an Nz coefficient which is equal to or larger than 0 and smaller than 1.

(3)

The liquid crystal device described in the paragraph (2), in which the retardation layer has the Nz coefficient which is equal to or larger than 0 and equal to or smaller than 0.5.

(4)

The liquid crystal device described in any one of the paragraphs (1) to (3), in which the retardation layer and the liquid crystal layer both function as a λ/4 plate having a broad-band.

(5)

The liquid crystal device described in any one of the paragraphs (1) to (4), in which the liquid crystal device includes a first substrate and a second substrate between which the liquid crystal layer and the reflective layer are both sandwiched;

the first substrate is disposed on a side opposite to a side to which the outside light is made incident in relation to the liquid crystal layer;

the second substrate is disposed on a side to which the outside light is made incident in relation to the liquid crystal layer; and

the retardation layer and the polarizing plate are disposed on the side to which the outside light is made incident in relation to the second substrate.

(6)

The liquid crystal device described in the paragraph (5), in which the first substrate includes a switching element and a pixel electrode connected to the switching element every pixel, and includes a common electrode which is formed so as to be common to pixels, and in which plural slits are formed in positions facing corresponding one of the pixel electrodes; and

the pixel electrodes and the common electrode both function as the reflective layer.

(7)

The liquid crystal device described in the paragraph (6), in which the switching element includes a terminal electrode; and

each of the pixel electrodes is formed in the same layer as that of the corresponding one of the terminal electrodes.

(8)

An electronic apparatus including a liquid crystal device as a display portion,

the liquid crystal device including:

a liquid crystal layer;

a reflective layer for reflecting an outside light made incident thereto through the liquid crystal layer; and

a retardation layer and a polarizing plate both disposed on a side to which the outside light is made incident in relation to the liquid crystal layer,

wherein the retardation layer has optical biaxial property.

The present technology contains subject matter related to that disclosed in Japanese Priority Patent Application JP 2011-113951 filed in the Japan Patent Office on May 20, 2011, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. A liquid crystal device, comprising:
a liquid crystal layer;
a reflective layer for reflecting an outside light made incident thereto through said liquid crystal layer; and
a retardation layer and a polarizing plate both disposed on a side to which the outside light is made incident in relation to said liquid crystal layer,
wherein said retardation layer has an optical biaxial property.

2. The liquid crystal device according to claim 1, wherein said retardation layer has an Nz coefficient which is equal to or larger than 0 and smaller than 1.

3. The liquid crystal device according to claim 2, wherein said retardation layer has the Nz coefficient which is equal to or larger than 0 and equal to or smaller than 0.5.

4. The liquid crystal device according to claim 1, wherein said retardation layer and said liquid crystal layer both function as a λ/4 plate having a broad-band.

5. The liquid crystal device according to claim 1, wherein
said liquid crystal device includes a first substrate and a second substrate between which said liquid crystal layer and said reflective layer are both sandwiched;
said first substrate is disposed on a side opposite to a side to which the outside light is made incident in relation to said liquid crystal layer;
said second substrate is disposed on a side to which the outside light is made incident in relation to said liquid crystal layer; and
said retardation layer and said polarizing plate are disposed on the side to which the outside light is made incident in relation to said second substrate.

6. The liquid crystal device according to claim 5, wherein
said first substrate includes a switching element and a pixel electrode connected to said switching element every pixel, and includes a common electrode which is formed so as to be common to pixels, and in which plural slits are formed in positions facing corresponding one of said pixel electrodes; and
said pixel electrodes and said common electrode both function as said reflective layer.

7. The liquid crystal device according to claim 6, wherein
said switching element includes a terminal electrode; and
each of said pixel electrodes is formed in the same layer as that of the corresponding one of said terminal electrodes.

8. An electronic apparatus, comprising
a liquid crystal device as a display portion,
said liquid crystal device including:
a liquid crystal layer;
a reflective layer for reflecting an outside light made incident thereto through said liquid crystal layer; and
a retardation layer and a polarizing plate both disposed on a side to which the outside light is made incident in relation to said liquid crystal layer,
wherein said retardation layer has an optical biaxial property.
